(19) United States
(12) Patent Application Publication
(10) Pub. No.: US 2003/0128447 A1
(43) Pub. Date: Jul. 10, 2003

(54) Inspection mirror

(76) Inventor: Timothy S. Goodenough, Granbury, TX (US)

Correspondence Address: James E. Bradley, BRACEWELL & PATTERSON, LLP, Suite 2900, 711 Louisiana Street, Houston, TX, 77002-2781, US

(21) Appl. No.: 10/041,340

(22) Filed: Jan. 7, 2002

(51) Int. Cl. G02B 7/182

(52) U.S. Cl. 359/882; 359/875

(57) ABSTRACT

An inspection device provides a mirror assembly having first and second mirrors connected with a hinge, the first mirror being movable relative to the second mirror, reflective surfaces of the mirrors being oriented to face one another when the first mirror is rotated toward the second mirror. A handle extends from the mirror assembly for the user to position the mirror assembly in the desired location and orientation. The image of an object is reflected in the first mirror and into the second mirror, the image being inverted or reversed in the first mirror and corrected in the second mirror, allowing for the user to easily read markings during the inspection. The mirrors may be of various shapes, sizes, and contours. A control on the handle allows remote mirror repositioning. A light source may be attached to the device.

### BACKGROUND OF THE INVENTION

1. Field of the Invention

This invention generally relates to inspection devices and particularly relates to an inspection device providing a non-inverted image.

2. Description of the Prior Art

Mirrors have been used in the past to inspect objects located in inaccessible areas. Mirrors are typically mounted to handles for positioning the mirrors in the desired areas, and these mirrors are mounted at fixed angles or may be mounted in a way that allows for rotation of the mirror relative to the handle. However, images reflected in a mirror are inverted, making inspections difficult, especially when inspection requires reading of numbers or other markings. Therefore, there is a need for an adjustable inspection device providing a non-inverted image.

### SUMMARY OF THE INVENTION

An inspection device provides a mirror assembly having first and second mirrors connected with a hinge, the first mirror being movable relative to the second mirror, reflective surfaces of the mirrors being oriented to face one another when the first mirror is rotated toward the second mirror. A handle extends from the mirror assembly for the user to position the mirror assembly in the desired location and orientation. The image of an object is reflected in the first mirror and into the second mirror, the image being inverted in the first mirror and corrected in the second mirror, allowing for the user to easily read markings during the inspection. The mirrors may be of various shapes, sizes, and contours. One embodiment of the invention provides for a mechanism of remote mirror repositioning. Another embodiment provides for a light source to be attached to the device.

### BRIEF DESCRIPTION OF THE DRAWINGS

The novel features believed to be characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a perspective view of an inspection device constructed in accordance with the present invention.

FIG. 2 is a schematic, perspective view of the device of FIG. 1, showing an image reflected in the mirrors of the device.

FIG. 3 is an alternative embodiment of the device of the present invention having round mirrors of differing sizes.

FIG. 4 is a second alternative embodiment of the device of the present invention having rectangular mirrors of differing sizes.

FIG. 5 is a third alternative embodiment of the device of the present invention having at least one trapezoidal mirror.

FIG. 6 is a fourth alternative embodiment of the device of the present invention having a mechanism for rotating the first mirror.

FIG. 7 is a fifth alternative embodiment of the device of the present invention having a light source attached to the device.

### DETAILED DESCRIPTION OF THE INVENTION

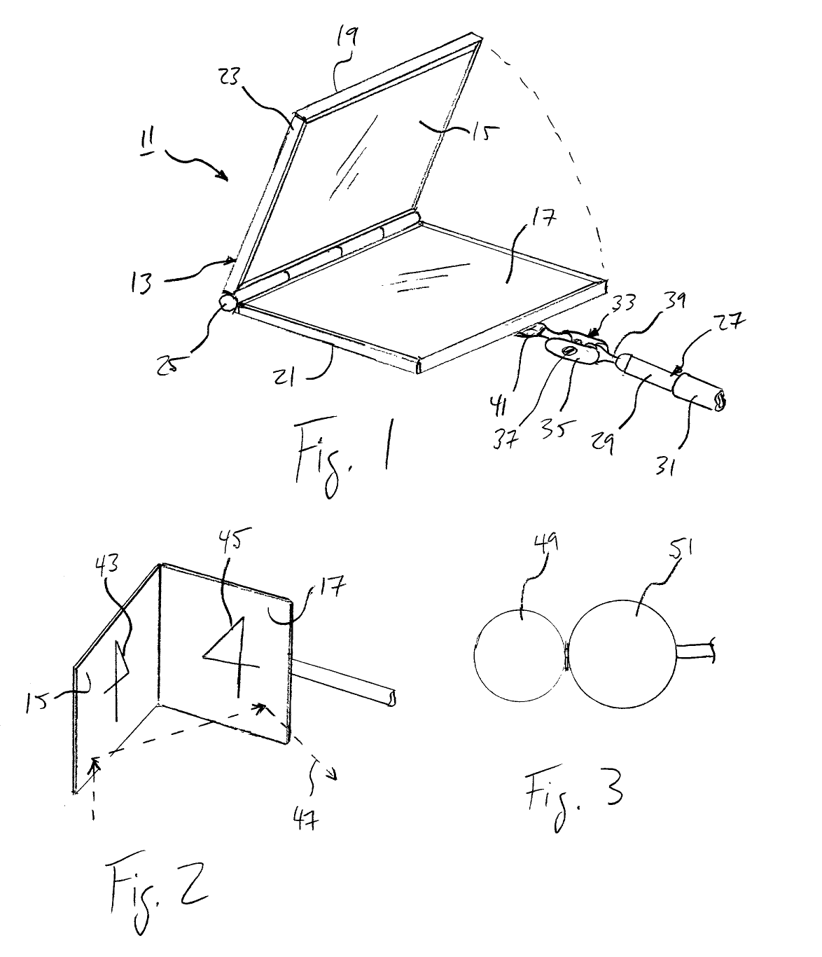

FIG. 1 shows an inspection device 11 having a hinged mirror assembly 13 for providing a non-inverted image of an object. Mirror assembly 13 comprises first mirror 15 and second mirror 17, mirrors 15, 17 being held in frames 19, 21, respectively. Frames 19, 21 are formed to have tabs 23 extending for the length of the outer edges of frames 19, 21 for retaining mirrors 15, 17 within frames 19, 21. Tabs 23 can be bent to allow mirrors 15, 17 to be removed from and inserted into frames 19, 21. Frames 19, 21 are connected to each other at adjacent edges by hinge 25, hinge 25 allowing frames 19, 21 to be rotated relative to each other for moving mirrors 15, 17 to desired rotational positions. Though shown as being flat and having the same shape and size, mirrors 15, 17 maybe of other shapes and sizes, as discussed below. Preferably, frames 19, 21 can be moved to a closed position, in which mirrors 15, 17 face each other in parallel planes, protecting mirrors 15, 17 from damage during storage, and a fully-open position, in which mirrors 15, 17 are rotated at least 135 degrees relative to each other.

A handle assembly 27 is mounted to the backside of frame 21 to enable a user to position mirror assembly 13 in a desired position. Handle assembly 27 is preferably telescoping, with shaft 29 being slidable within shaft 31. Though not shown, shaft 31 preferably has a grip at its outer end for the user to grasp shaft 31.

To allow for mirror assembly 13 to be rotated relative to handle assembly 27, a hinge assembly 33 comprises two plates 35 held together by fastener 37 for rotatably capturing spherical ends of posts 39, 41. Post 39 is attached to the inner end of shaft 29, and post 41 is attached to frame 21. Hinge assembly 33 allows handle assembly 27 to be moved in three directions relative to mirror assembly 13.

During use of device 11, the user positions mirrors 15, 17 to approximately 90° relative to each other, then grasps handle assembly 27 to lift and position mirror assembly 13 in a desired position. The user then moves mirror assembly 13 near the object to be inspected, an inverted image of the object being reflected in one of mirrors 15, 17, for example, mirror 15. The user then rotates or otherwise positions mirror 17 to reflect the image from mirror 15 onto mirror 17 and to the user. FIG. 2 illustrates the reflection of an inverted image 43 on mirror 15, onto mirror 17 as a corrected image 45, then toward the user. Trace lines 47 indicate the path of light rays during use of device 11. If necessary, the user will withdraw device 11 from the inspection area to reposition mirrors 15, 17 relative to each other or to reposition mirror assembly 13 relative to handle assembly 27.

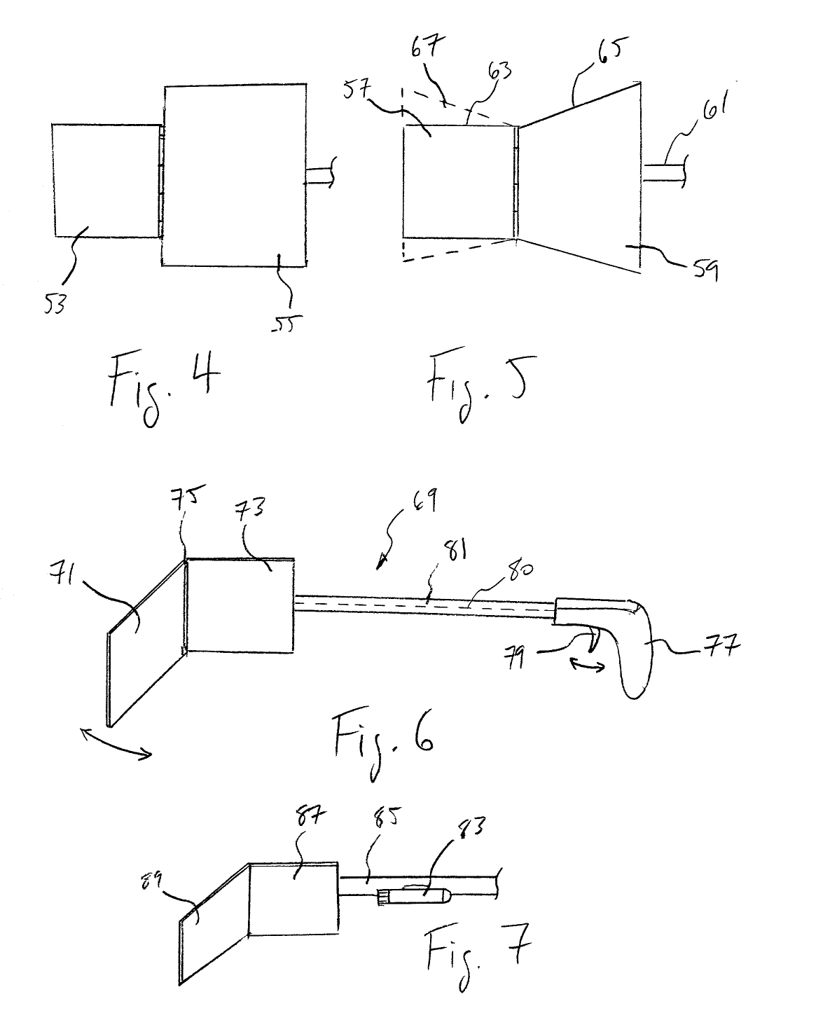

Several alternative embodiments of the present invention are shown in FIGS. 3 through 7. FIGS. 3 through 5 show alternative mirrors shapes and sizes with all of the mirrors shown as lying in the same plane. In FIG. 3, mirrors 49, 51 each have a circular shape in plan view, which may be required for access to certain inspection areas. Mirrors 49, 51 may be concave or convex, providing for magnification or a for wider view of the inspection area. Additionally, mirror 51 is larger than mirror 49, allowing the user to see all of mirror 49 when mirrors 49, 51 are rotated through minimal angles. Likewise, FIG. 4 shows mirrors 53, 55 that are rectangular, mirror 55 being larger than mirror 53.

Mirrors 57, 59 in FIG. 5 provide an additional alternative for viewing all of mirror 57 in mirror 59. Mirror 59 has a trapezoidal shape, the large base being oriented toward handle 61. As mirrors 57, 59 are positioned at an angle relative to each other and handle 61 is rotated, upper edge 63 of mirror 57 and upper edge 65 of mirror 59 align, allowing for a full view of mirror 57 in mirror 59. Mirror 57 may also have a trapezoidal shape, indicated by lines 67.

In order to reposition the mirrors in the embodiments describe above, the user must withdraw the device from the inspection area and manually realign the mirrors. FIG. 6 shows a device 69 providing a mechanism for remotely adjusting the angle of mirrors 71, 73 about hinge 75. The user grasps grip 77, which has a finger-operated trigger 79 for moving mirror 71 relative to mirror 73. A cable 80 or other linkage extends from trigger 79 to mirror 71 through handle 81. Though shown with trigger 79, device 69 may be constructed to have other types of manually-operated or powered actuators for moving mirror 71.

To provide a light source close to the inspected object, FIG. 7 shows flashlight 83 mounted to handle 85, light emitted from flashlight 83 reflecting from mirror 87 to mirror 89 and to the object to be inspected. The image of the object is then reflected onto mirror 89, onto mirror 87, and then back to the user.

The present invention provides several advantages. By providing two mirrors, a user can view a non-inverted image of an object to be inspected. This allows the user to easily read labels or other markings on the object. A telescoping handle allows for the user to position the mirrors at a distance from the user, and the hinge assembly provides for rotation of the mirror assembly relative to the handle. When the second mirror is larger than the first mirror, a larger area of the first mirror may be visible when the mirrors are at angles to the user. An optional mechanism provides for remote manipulation of the first mirror, and a light source can be attached to the handle for illuminating objects.

While the invention has been shown in only one of its forms, it is not thus limited but is susceptible to various changes and modifications without departing from the spirit thereof.

I claim:

1. An inspection device, comprising:
a mirror assembly having first and second mirrors, the first mirror being movable relative to the second mirror such that an image of an object reflected in the first mirror is reflected and reversed in the second mirror; and
a handle extending from the mirror assembly.

2. The device of claim 1, wherein:
the mirrors are connected to each other by a hinge.

3. The device of claim 2, wherein:
the mirrors are movable from a closed position, wherein the mirrors are in parallel planes, to a position at which the relative angle between the first and second mirrors is approximately 135 degrees.

4. The device of claim 1, wherein:
the handle is telescoping.

5. The device of claim 1, wherein:
the mirrors have a rectangular shape in plan view.

6. The device of claim 1, wherein:
the mirrors have a circular shape in plan view.

7. The device of claim 1, wherein:
the mirrors have a trapezoidal shape in plan view.

8. The device of claim 1, wherein:
the first mirror has a rectangular shape in plan view; and
the second mirror has a trapezoidal shape in plan view.

9. The device of claim 1, further comprising:
a control member mounted to the handle; and
a linkage extending from the control member to the first mirror for manually moving the first mirror on the hinge relative to the second mirror.

10. The device of claim 1, further comprising:
a light source attached to the handle and emitting light toward the mirror assembly for illuminating objects to be inspected.

11. The device of claim 1, wherein:
the mirrors have different sizes.

12. The device of claim 1, further comprising:
a swivel connecting the mirror assembly to the handle.

13. An inspection device, comprising:
first and second mirrors, the first mirror being hinged to the second mirror, the mirrors being movable relative to each other such that an image of an object reflected in the first mirror is reflected and reversed in the second mirror; and
a handle extending from the second mirror; and wherein
the mirrors are movable from a closed position, wherein the mirrors are in parallel planes, to a position at which the relative angle between the first and second mirrors is approximately 135 degrees.

14. The device of claim 13, wherein:
the handle is telescoping.

15. The device of claim 13, wherein:
the mirrors have a rectangular shape in plan view.

16. The device of claim 13, wherein:
the mirrors have a circular shape in plan view.

17. The device of claim 13, wherein:
the mirrors have a trapezoidal shape in plan view.

18. The device of claim 13, wherein:
the first mirror has a rectangular shape in plan view; and
the second mirror has a trapezoidal shape in plan view.

19. The device of claim 13, further comprising:
a control member mounted to the handle; and
a linkage extending from the control member to the first mirror for manually moving the first mirror on the hinge relative to the second mirror.

20. An method of inspection, comprising:
(a) providing a mirror assembly having first and second mirrors, the first mirror being movable relative to the second mirror, a handle extending from the mirror assembly;
(b) positioning the mirror assembly near an object such that an image of the object is reflected in the first mirror; and
(c) moving the first mirror relative to the second mirror such that the image in the first mirror is reflected and reversed in the second mirror for viewing by a user.
